(19) United States
(12) Patent Application Publication
(10) Pub. No.: US 2016/0125468 A1
(43) Pub. Date: May 5, 2016

(54) SYSTEM, METHOD, AND APPARATUS FOR PROVIDING CONTENT IN A NETWORK ENVIRONMENT

(71) Applicant: Free ATM, Inc., Brooklyn, NY (US)

(72) Inventors: Marque Staneluis, Brooklyn, NY (US); Eric Fondren, Brooklyn, NY (US); Clinton Townsend, South Orange, NJ (US)

(21) Appl. No.: 14/932,835

(22) Filed: Nov. 4, 2015

Related U.S. Application Data
(60) Provisional application No. 62/075,164, filed on Nov. 4, 2014.

(51) Int. Cl. G06Q 30/02

(52) U.S. Cl. CPC G06Q 30/0264

(57) ABSTRACT

System, methods and apparatus for displaying content in an automated teller machine (ATM) network are provided. The systems and methods include ways to maximize content impressions on displays in an ATM network that are not always accessible to the general public. The methods and systems compute the maximum possible content impressions and then time shift content when there is a conflict in content display timing, ensuring an even distribution of content impressions across a series of networked displays.

### CROSS REFERENCE TO RELATED APPLICATIONS

The present application claims the benefit of U.S. Provisional Application No. 62/075,164 filed 4 Nov. 2015; which is incorporated herein by reference in its entirety.

### TECHNOLOGICAL FIELD

The present disclosure relates generally to a system, method and apparatus for displaying content in a network environment and more particularly to systems, methods and apparatuses for providing content in a networked environment in conjunction with an automated teller machine (ATM) network.

### BACKGROUND

ATM machines have replaced the traditional visit to the bank. Consumers regularly use ATM machines to carry out a variety of financial transactions, such as withdrawal of cash from bank accounts, to make deposits, and to check balances. On average, the American consumer uses an ATM 10 times per month. Consequently, ATM machines are widely dispersed in a variety of locations ranging from banks, to convenience stores, to train stations, to airports, to virtually any place a consumer may need to obtain cash and access their financial information.

While ATM machines may be standalone devices, they are typically connected to a central location via wired or wireless network connections. Because of the nature of their wide distribution and network connectivity, the screens of the ATM machines provide a perfect platform to display content or advertisements when not servicing customers. The problem with this, however, is that ATMs are designed for privacy and allow only the user to view the active display screen, thereby limiting their viability as wide spread content platforms. Accordingly, a need exists to enhance the exposure to those in proximity to the ATM to allow content to be seen on a supplemental display for people who may not be using the ATM at the time but who may be in proximity to the ATM.

Such a display of content may allow the party hosting or the owner of the ATM to supplement the ATM fees with content or advertising revenue, thereby incentivizing customers to frequent the ATM.

Further, because ATMs are not typically displayed in the open like a billboard, it is difficult to determine how many viewers or impressions might be served to consumers by an ad displayed on an ATM device. Accordingly, a need exists for a means to accurately calculate the number of impressions served by a display in the vicinity of an ATM device.

Still further, ATMs are designed to be secure and limit network access. Because of this it is difficult to vary the content displayed on an ATM. Accordingly a need exists for a system and method that can allow software and content updates to the ATM without interrupting the operation and availability of the ATM.

Electronic advertising and content display is generally bought/sold on a cost per thousand impressions or CPM (“Cost Per Mil”). When this is done for mobile devices or websites, an impression is pretty easy to define, i.e., one ad displayed on one user device equals one impression. On a passive unit, such as a display kiosk or display unit this is more complicated. It is not exactly known how many people have seen the content or if any one has seen it. Because of this, impression counts become more of a calculation based on probabilities of viewership attributed to a number of values, including foot traffic and dwell time, rather than a direct count. When the passive unit is in a location, such as on a street, it may be possible to count potential viewers during a given period of time. The value of the location is then calculated using a pricing index developed by Nielsen® company. When a passive unit is in a location where access is limited and or restricted, it may be more difficult to place a value on such a location. Accordingly a need exists to reasonably and accurately calculate the CPM for display units that are not always accessible to the general public.

Additionally, access to ATMs and display units within buildings and stores may be limited, the availability to display content is also limited. This often results in scheduling difficulties because displays may not be available during off hours. Accordingly a need exists to ensure that content is efficiently scheduled for the displays within the network which have limited availability.

### SUMMARY OF THE INVENTION

Systems, methods, apparatuses and computer program products are provided herein for providing services and content on a display.

In some embodiments, content is scheduled to efficiently maximize user impressions on a series of networked display units. In an embodiment, the total number of available impressions is distributed through a geographic network of display units.

In an embodiment, display units are associated with ATM machines. In an embodiment content is displayed over an ATM network. In an embodiment targeted content via ATM machines and display units is disclosed. In an embodiment, simultaneous content may be display on display units and ATM machines.

In an embodiment, a system and method for accurately calculating the number of impressions served by a display in the vicinity of an ATM device are calculated. In another embodiment, systems and method that can allow software and content updates to the ATM without interrupting the operation and availability of the ATM and or external displays is disclosed.

In an embodiment, a system for displaying content is described. The system comprises a content display unit for displaying content, a content storage unit for storing prerecorded content, a scheduler for selecting the content to be displayed on the display unit, wherein the scheduler selects the content for display based on a number of available display units, a total number of desired impressions, and a total number of impressions available.

In another embodiment, the scheduler comprises a microprocessor and the total number of impressions available is determined via the processor based on the number of available units and a number of time slots available for each of the available units.

In another embodiment, the content display units are incorporated into an ATM machine. In still another embodiment, the content display unit are incorporated into an ATM network. In still another embodiment, the content display unit are stand alone display units that are coupled to an ATM network.

In an embodiment, a method for displaying a plurality of content is described. The method includes determining via a processor a number of available display units for displaying the plurality of content; determining, by the processor, a first content position for a first content within a temporal data stream; computing, by the processor, a second content position for the first content within the temporal data stream; determining, by the processor, a first content position for a second content within a temporal data stream; comparing, by the processor, the first content position for the first content with the first content position for the second content to determine if there is a conflict; time shifting the first content position in a first temporal direction for the second content by a content position unit within the temporal data stream if the comparing determine there is a conflict; computing, by the processor, a second content position for the second content within the temporal data stream; comparing, by the processor, the second content position for the first content with the second content position for the second content to determine if there is a conflict; time shifting, by the processor, the second content position in a temporal direction opposite the first temporal direction for the second content by the content position unit within the temporal data stream if the comparing determine there is a conflict.

In still another embodiment, the method comprises determining, by the processor, a total number of impressions available via the microprocessor based on the number of available units and a number of time slots available for each of the available units. In still another embodiment, the available display units are associated with an ATM machine. In still another embodiment, the available display units are associated with an ATM network. In still another embodiment, the available display units comprises display units incorporated into ATM machines.

In an embodiment, the length of the first or second content requires multiple adjacent time slots to be displayed. In still another embodiment, the processor determines a max_block value of contiguous time slots required to display the first or second content; and a number of available contagious available time slots in the temporal data stream; and compares the number of available contiguous time slots to the determined max_block value available and then inserts in the temporal data stream the first or second content if the comparing by the processor determines that the number of available contagious available time slots is greater than or equal to the max_block value.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 depicts a display according to an embodiment of the present disclosure.

FIG. 2 depicts a system for providing services on an ATM network in accordance with an embodiment of the present disclosure.

FIG. 3 is a block diagram of a typical ATM in accordance with an embodiment of the present disclosure.

FIG. 4 is a block diagram of a backend apparatus in accordance with an embodiment of the present disclosure.

FIG. 5 is a block diagram of a content server in an embodiment of the present disclosure.

FIGS. 6A and 6B depict scheduling diagrams in an embodiment of the present disclosure.

FIG. 7A depicts a flow diagram of a conflict management policy in an embodiment of the present disclosure.

FIGS. 7B-7D depict scheduling diagrams in an embodiment of the present disclosure.

FIG. 8 depicts a scheduling diagram in an embodiment of the present disclosure.

FIG. 9 depicts a flow diagram of a conflict management policy in an embodiment of the present disclosure.

FIG. 10 depicts a scheduling diagram in an embodiment of the present disclosure.

FIG. 11 depicts a scheduling diagram in an embodiment of the present disclosure.

FIG. 12 depicts a flow chart of a scheduler in an embodiment of the present disclosure.

FIG. 13 depicts a general computer architecture on which the present teaching can be implemented.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Further, data may be received through various wired and/or wireless networks or connections.

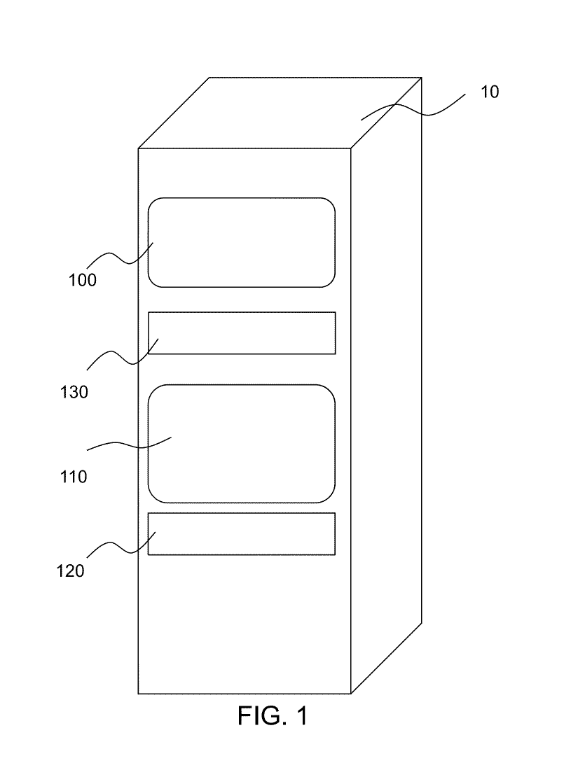

FIG. 1 illustrates a kiosk 10 in an embodiment of the present disclosure. As used herein, the kiosk may be an ATM, but it is understood, that kiosk 10 could be any type of free standing point of sale unit, advertising terminal or display. Kiosk or ATM 10 may contain a display unit 100, a transaction display 110, a data entry terminal 120 and additional identification signage 130. In an embodiment, display unit 100 may be a display, such as a CRT, LCD, LED or plasma display. Display unit 100 may be an all in one computer, such as a tablet computer or may be just the display portion of a computer. Display unit 100 may have logic and control circuitry as well as memory, communication and driver circuitry. Display unit 100 may be built into ATM 10 or may be externally mounted on ATM 10. Display unit 100 may include a keyboard, a keypad, a display, a touch screen display, a microphone, a speaker, and/or other input/output mechanisms. Display unit 100 may also include a camera or other visual sensor to detect users, passersby and other human traffic in the area. Display unit 100 is intended to display content to the ATM 10 user as well as those in proximity to ATM 10. Display 100 may contain an audio portion. Display 100 may be used to display both fixed images as well as video images. Display 100 may display stored as well as live or streamed images. Display unit 100 may be intended to be exposed to the elements or may be housed behind a protective layer that allows images to be displayed. Display unit 100 may be coupled to the same network at ATM 10 or may be coupled to a separate network.

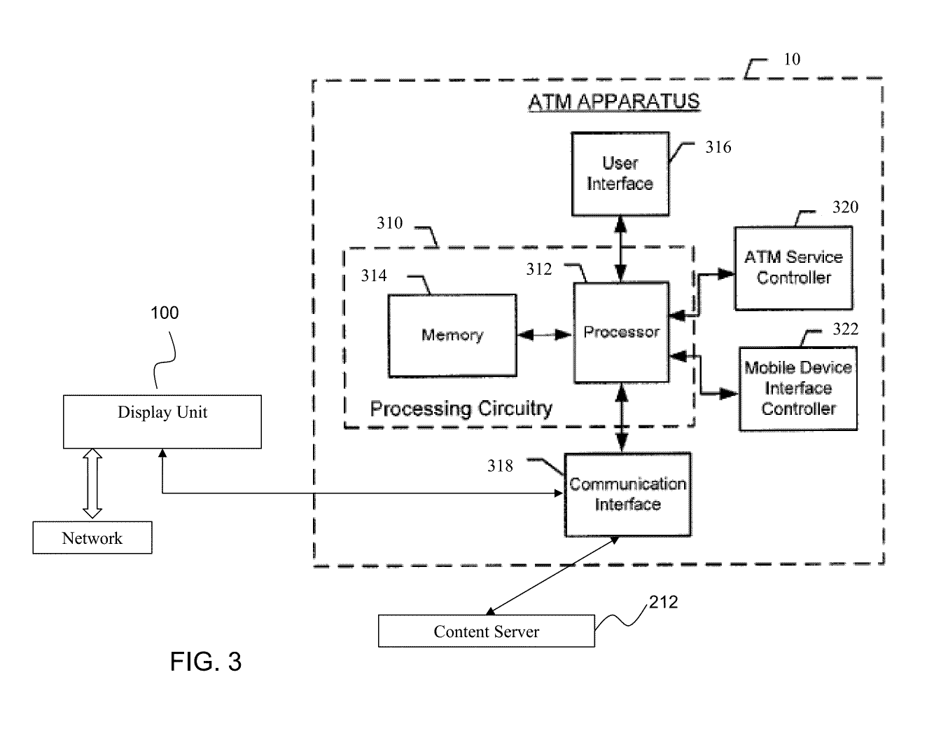

Transaction display 110, which will be described more fully with respect to FIG. 3 and may include, for example, a keyboard, a keypad, a, a display, a touch screen display, a microphone, a speaker, and/or other input/output mechanisms. As such, the transaction display 110 may, in some embodiments, provide means for facilitating ATM transactions. For example, the transaction display 110 may provide means for user input such as touch screen display, voice commands, and/or the like by which a user may enter account information, input information that may be needed for carrying out an ATM transaction, and/or the like. Additionally or alternatively, transaction display 110 may provide means for user input for utilizing services that may be provided by an ATM 100 of some example embodiments, such as for purchasing products. The transaction display 110 may additionally or alternatively provide means for providing output to a user. In this regard, transaction display 110 may display transaction information, product offerings, advertising, and/or the like to the user.

Data entry terminal 120 allows for user interaction with kiosk 10. As such, data entry terminal 120 may include, for example, a keyboard, a keypad, a mouse, a joystick, a microphone, a speaker, and/or other input/output mechanisms. As such, data entry terminal 120 may, in some example embodiments, provide means for facilitating ATM transactions. For example, the data entry terminal 120 may provide means for user input such as a card reader (e.g., a debit/credit card reader), voice commands, and/or the like by which a user may enter account information, input information that may be needed for carrying out an ATM transaction, and/or the like. Additionally or alternatively, the data entry terminal 120 may provide means for user input for utilizing services that may be provided by an ATM. The data entry terminal 120 may additionally or alternatively provide means for providing output to a user. In this regard, data entry terminal 120 may display transaction information, product offerings, content, advertising, and/or the like to the user. In some example embodiments, the data entry terminal 120 may include a printer, which may print transaction receipts, advertising, coupons, and/or the like for a user.

Identification signage 130 may be any fixed display of images or text and may be used to identify the owner of the kiosk 10 or may be an advertisement or other static message. Identification signage 130 may be updateable or may be permanent Identification signage 130 may additionally or alternatively provide means for providing output to a user. In this regard identification signage 130 may display transaction information, product offerings, advertising, and/or the like to the user. In some example embodiments, Identification signage 130 may include a printer, which may print advertising, coupons, and/or the like for a user.

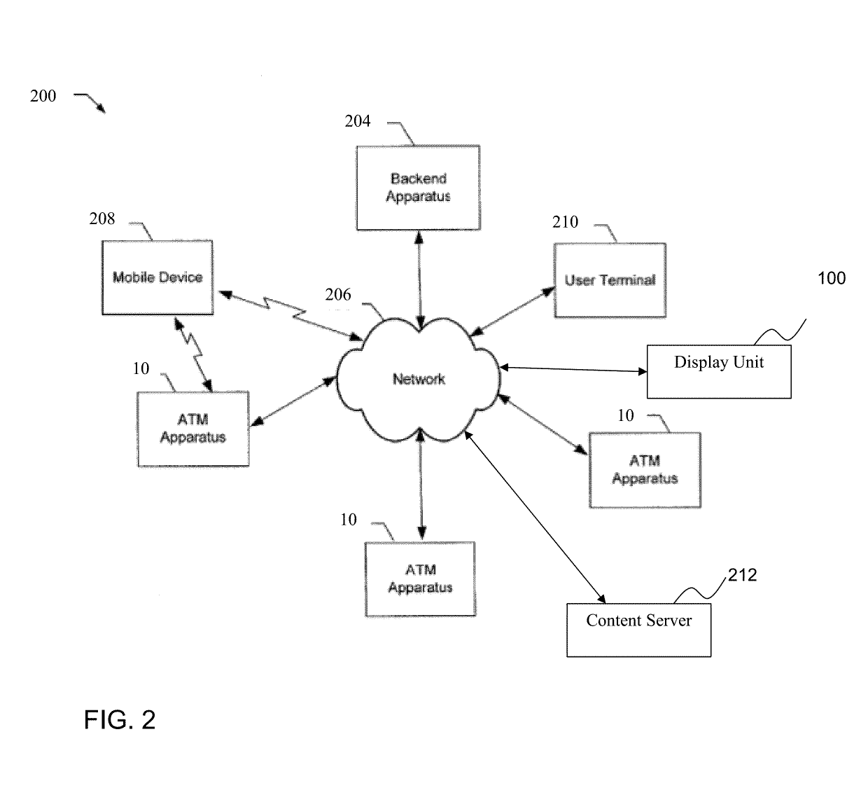

FIG. 2 illustrates a system 200 for providing services on an ATM according to some embodiments. System 200 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 2 illustrates one example of a configuration of a system for providing services on a kiosk or ATM in accordance with the present disclosure, numerous other configurations may also be used to implement embodiments of the present invention.

The system 200 may include one or more ATM apparatuses 10. While three such ATM apparatuses 10 are illustrated in FIG. 2, it will be appreciated that this illustration is by way of example, and not by way of limitation, as the system 200 may include additional or fewer ATM apparatuses 10. An ATM apparatus 10 may comprise any computing device configured to provide ATM transaction services. As will be described further herein below, in some example embodiments, an ATM apparatus 10 may be configured to present content or advertising to ATM users. In an embodiment, some of the ATM apparatus 10 connected to network 206 are configured with display units 100. Additionally and/or alternatively, display units 100 may be connected directly the network 206 without an ATM device. While all ATM apparatuses 10 may have a display unit 100, it is not necessary that all ATM apparatuses connected to network 206 have a display unit 100. Additionally or alternatively, in some example embodiments, an ATM apparatus 10 may be configured to function as a services kiosk through which a user may purchase products, services, offers, and/or the like (interchangeably referred to herein as “products”).

In an embodiment, the network may further consists of multiple sub-systems such as a CMS/Scheduler, a bridge and third-party applications for remote management of ATMs and/or display units.

The system 200 may include a backend apparatus 204. The backend apparatus 204 may be embodied as one or more computers, one or more workstations, one or more network nodes, one or more servers, a server cluster, a cloud computing infrastructure, multiple computing devices in communication with each other, any combination thereof, and/or the like. The backend apparatus 204 may be configured to support a network of one or more ATM apparatuses 10 and display units 100 or may be connected to any other wide area network such as the internet or a local area network. For example, the backend apparatus 204 may be configured in to support the processing of transactions that may be initiated via an ATM apparatus 10. In this regard, the backend apparatus 204 may be configured to interface with computing systems of financial service providers, such as over the network 206 in order to facilitate account withdrawals, deposits, and/or other financial transactions that may be carried out on an ATM apparatus 10. Additionally or alternatively, the backend apparatus 204 may be configured to drive content to an ATM or display units 100 which may be presented to a user or someone in proximity with the ATM via display unit 100. In an embodiment, backend apparatus 204 is in communications with a content server 212 or additionally functions as a content server 212.

The backend apparatus 204 may be configured to communicate with one or more ATM apparatuses 10 or with the display units 100 over network 206 in order to support operation of the ATM apparatuses 10 and/or the display of content on display units 100. The network 206 may comprise any data network that may facilitate the communication of data. The network 206 may comprise a wired or wireless network (e.g., a cellular network, wireless local area network, wireless wide area network, some combination thereof, or the like), or a combination thereof, and in some embodiments comprises at least a portion of the Internet.

System 200 may comprise one or more mobile devices 208 such as a tablet computing device, mobile computer, smart phone, mobile communication device, digital camera/camcorder, mobile audio/video player, mobile digital video recorder, chipset, any combination thereof, and/or the like. The mobile device 208 may be configured to connect to the network 206 to access information about the network of ATM apparatuses 10 in the system 200. This information may, for example, be accessed by a web interface that may be provided by the backend apparatus 204 in some example embodiments. Additionally or alternatively, the information may, be accessed via an application that may be provided by some example embodiments, which may be implemented on a mobile device 208. Information about the network of ATM apparatuses that may be accessed may include locations of ATM apparatuses 10, product offerings that may be purchased at various ATM apparatuses 10, available content, and/or the like.

In some example embodiments, the system 200 may additionally comprise one or more user terminals 210. A user terminal 210 may comprise any computing device that may be configured to connect to the network 206, such as to access information about the network of ATM apparatuses 10 in the system 200. For example, a user terminal 210 may be configured to access a web interface that may be provided by the backend apparatus 204 in some example embodiments to facilitate user interaction with the interface to retrieve information about the network of ATM apparatuses 10, purchase product offerings that may be associated with the network of ATM apparatuses 10, manage content and/or the like. A user terminal 210 may be embodied as a desktop computer, laptop computer, tablet computing device, mobile phone, and/or the like.

System 200 may comprise one or more content servers 212. Content server 212 may store, manage, select, catalog, index and/or identify content to be displayed on display unit 100. In an embodiment, content server 212 may have internal storage memory or may interface with any type of other external memory storage device such as a bulk memory, cloud storage, removable storage or any other type of content hosting device. Content server 212 may index content and may simply store links and/or other index information about content and need not necessarily directly store content itself. Content server 212 may be any type of computing device and may be part of backend apparatus 204 or may be a stand alone unit.

FIG. 3 illustrates a block diagram of an ATM apparatus 10 in accordance with some example embodiments. However, it should be noted that the components, devices or elements illustrated in and described with respect to FIG. 3 may not be mandatory and thus some may be included and/or omitted in certain embodiments.

The ATM apparatus 10 may include or otherwise be in communication with processing circuitry 310 that is configurable to perform actions in accordance with one or more embodiments disclosed herein. In this regard, the processing circuitry 310 may be configured to perform and/or control performance of one or more functionalities of the ATM apparatus 10 in accordance with various example embodiments, and thus may provide means for performing functionalities of the ATM apparatus 10 in accordance with various example embodiments.

The processing circuitry 310 may be configured to perform data processing, application execution and/or other processing and management services according to one or more embodiments. In some embodiments, the ATM apparatus 10 or a portion(s) or component(s) thereof, such as the processing circuitry 310, may be embodied as or comprise a chip or chip set. The ATM apparatus 10 or the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The ATM apparatus 10 or the processing circuitry 310 may therefore, be configured to implement an embodiment of the invention on a single chip or as a single “system on a chip.” As such, in some cases, a chip or chipset may constitute means for performing one or more operations for providing the functionalities described herein.

The processing circuitry 310 may include a processor 312 and, in some embodiments, such as that illustrated in FIG. 3, may further include memory 314. The processing circuitry 310 may be in communication with or otherwise control a user interface 316, a display unit 100, a transaction terminal 110, a user interface 120, a communication interface 318, an ATM service controller 320, and/or a mobile device interface controller 322. As such, the processing circuitry 310 may be embodied as a circuit chip (e.g., an integrated circuit chip) configured (e.g., with hardware, software or a combination of hardware and software) to perform operations described herein.

In some example embodiments, the memory 314 may include one or more non-transitory memory devices such as, for example, volatile and/or non-volatile memory that may be either fixed or removable. In this regard, the memory 314 may comprise a non-transitory computer-readable storage medium. It will be appreciated that while the memory 314 is illustrated as a single memory, the memory 314 may comprise a plurality of memories. The plurality of memories may be embodied on a single computing device or may be distributed across a plurality of computing devices collectively configured to function as the ATM apparatus 10. The memory 314 may be configured to store information, data, applications, instructions and/or the like for enabling the ATM apparatus 10 to carry out various functions in accordance with one or more example embodiments. For example, the memory 314 may be configured to buffer input data for processing by the processor 312. Additionally or alternatively, the memory 314 may be configured to store instructions for execution by the processor 312. As yet another alternative, the memory 314 may include one or more databases that may store a variety of files, contents or data sets. Among the contents of the memory 314, applications may be stored for execution by the processor 312 in order to carry out the functionality associated with each respective application. In some cases, the memory 314 may be in communication with one or more of the processor 312, user interface 316, communication interface 318, ATM service controller 320, or mobile device interface controller 322 via a bus(es) for passing information among components of the ATM apparatus 10.

The user interface 316 may be in communication with the processing circuitry 310 to receive an indication of a user input at the user interface 316 and/or to provide an audible, visual, mechanical or other output to the user. As such, the user interface 316 may include, for example, a keyboard, a keypad, a mouse, a joystick, a display, a touch screen display, a microphone, a speaker, and/or other input/output mechanisms. As such, the user interface 316 may, in some example embodiments, provide means for facilitating ATM transactions. For example, the user interface 316 may provide means for user input such as a card reader (e.g., a debit/credit card reader), keypad, touch screen display, voice commands, and/or the like by which a user may enter account information, input information that may be needed for carrying out an ATM transaction, and/or the like. Additionally or alternatively, the user interface 316 may provide means for user input for utilizing services that may be provided by an ATM apparatus 10 of some example embodiments, such as for purchasing products.

The user interface 316 may additionally or alternatively provide means for providing output to a user. In this regard, a display that may be provided by the user interface 316 may display transaction information, product offerings, advertising, and/or the like to the user. In some example embodiments, the user interface may take the form of an application based operating system that displays one or more applications “apps” that can be executed on the ATM apparatus 10. In some example embodiments, the user interface 316 may include a printer, which may print transaction receipts, advertising, coupons, and/or the like for a user.

The communication interface 318 may include one or more interface mechanisms for enabling communication with other devices and/or networks. In some cases, the communication interface 318 may be any means such as a device or circuitry embodied in either hardware, or a combination of hardware and software that is configured to receive and/or transmit data from/to a network and/or any other device or module in communication with the processing circuitry 310. By way of example, the communication interface 318 may be configured to enable the ATM apparatus 10 to communicate with the backend apparatus 204 via the network 206 or with the content sever 212 directly or through a network 206. Accordingly, the communication interface 318 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods. As a further example, the communication interface 318 may be configured to support a data connection between the ATM apparatus 10 and a mobile device 208. For example, the communication interface 318 may support a wireless connection with a mobile device 208, such as via a Bluetooth connection, RF connection, IR connection, wireless USB connection, WLAN connection, and/or the like. Communications interface 318 may also communicate directly with display unit 100 and/or may convey commands and information from/to the processing circuitry 310 or the content server 212. Display unit 100 may also communicate directly over a network 206 an may function independently from ATM apparatus 10.

In some embodiments, processor 312 (or the processing circuitry 310) may be embodied as, include, or otherwise control an ATM service controller 320 and display unit 100. As such, the ATM service controller 320 may be embodied as various means, such as circuitry, hardware, a computer program product comprising computer readable program instructions stored on a computer readable medium (for example, the memory 314) and executed by a processing device (for example, the processor 312), or some combination thereof. The ATM service controller 320 may be capable of communication with one or more of the memory 314, user interface 316, communication interface 318, or mobile device interface controller 322 to access, receive, and/or send data as may be needed to perform one or more of the functionalities of the ATM service controller 320 as described herein.

In some example embodiments, the ATM service controller 320 may be configured to control operation of the user interface 316. Thus, for example, where the ATM service controller 320 is described to cause output of information, such as by causing display of advertising, causing printing of a receipt, and/or the like, it will be appreciated that the ATM service controller 320 may cause output of information by controlling the user interface 316 to output the information. Additionally or alternatively, in some example embodiments, the ATM service controller 320 may be configured to control operation of the communication interface 318. Thus, for example, where the ATM service controller 320 is described to cause information to be sent to another computing device, such as to the backend apparatus 204 over the network 206, it will be appreciated that the ATM service controller 320 may cause the information to be sent by controlling the user interface 316 to send the information.

In some example embodiments, the ATM apparatus 10 may include a mobile device interface controller 322, which may be embodied by and/or otherwise controlled by the processor 312 (or the processing circuitry 310) and/or by the ATM service controller 320. As such, the mobile device interface controller 322 may be embodied as various means, such as circuitry, hardware, a computer program product comprising computer readable program instructions stored on a computer readable medium (for example, the memory 314) and executed by a processing device (for example, the processor 312), or some combination thereof. The mobile device interface controller 322 may be configured to control and/or otherwise facilitate communication with a mobile device 208. In this regard, the mobile device interface controller 322 may be configured to ascertain an identity that may be asserted and/or otherwise presented by a mobile device 208, such as by reading a barcode, RF identifier (RFID), and/or other indication of a user identity that may be presented to an ATM apparatus 10 by a mobile device 208. Additionally or alternatively, the mobile device interface controller 322 may be configured to control the provision of information to a mobile device 208, such as the provision of a bar code, product voucher, digital ticket, and/or other data that may be used to redeem a product that may be purchased at an ATM apparatus 10 in some example embodiments. As such, the mobile device interface controller 322 of some example embodiments may be configured to control operation of the communication interface 318 to cause data to be transmitted to and/or received from a mobile device 208. In some example embodiments, the mobile device interface controller 322 may be capable of communication with one or more of the memory 314, user interface 316, communication interface 318, or ATM service controller 320 to access, receive, and/or send data as may be needed to perform one or more of the functionalities of the mobile device interface controller 322 as described herein.

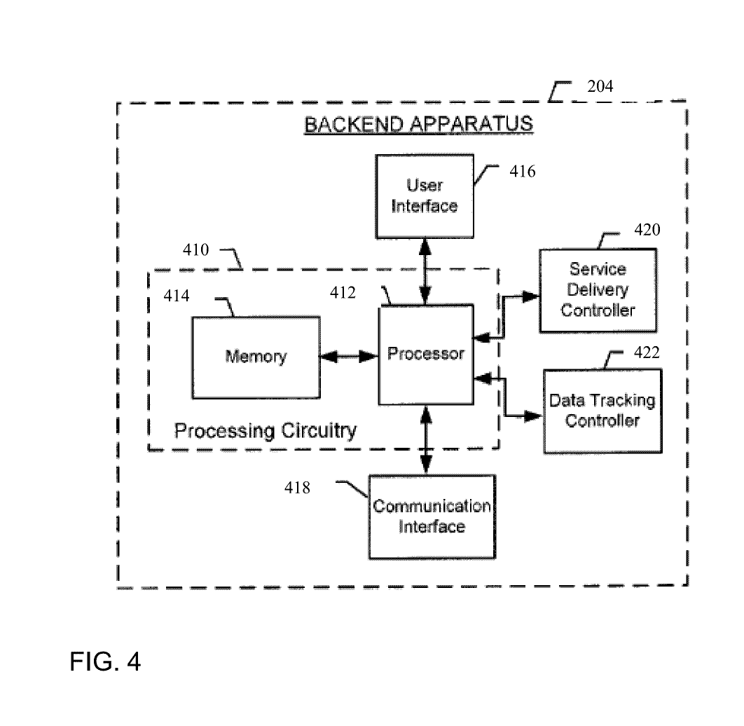

FIG. 4 illustrates a block diagram of a backend apparatus 204 in accordance with an embodiment of the present disclosure. However, it should be noted that the components, devices or elements illustrated in and described with respect to FIG. 4 below may not be mandatory and thus some may be omitted in certain embodiments. Additionally, some embodiments may include further or different components, devices or elements beyond those illustrated in and described with respect to FIG. 4.

The backend apparatus 204 may include or otherwise be in communication with processing circuitry 410 that is configurable to perform actions in accordance with one or more example embodiments disclosed herein. Backend apparatus 204 may also comprises content server 212 or may be in communications with content server 212. In this regard, the processing circuitry 410 may be configured to perform and/or control performance of one or more functionalities of the backend apparatus 204 in accordance with various example embodiments, and thus may provide means for performing functionalities of the backend apparatus 204 in accordance with various example embodiments. The processing circuitry 410 may be configured to perform data processing, application execution and/or other processing and management services according to one or more example embodiments. In some embodiments, the backend apparatus 204 or a portion(s) or component(s) thereof, such as the processing circuitry 410, may be embodied as or comprise a chip or chip set. In other words, the backend apparatus 204 or the processing circuitry 410 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The backend apparatus 204 or the processing circuitry 410 may therefore, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 410 may include a processor 412 and, in some embodiments, such as that illustrated in FIG. 4, may further include memory 414. The processing circuitry 410 may be in communication with or otherwise control a user interface 416, a communication interface 418, a service delivery controller 420, and/or a data tracking controller 422. As such, the processing circuitry 410 may be embodied as a circuit chip (e.g., an integrated circuit chip) configured (e.g., with hardware, software or a combination of hardware and software) to perform operations described herein. Backend apparatus 204 may perform some or all of the functions of the content server 212 and may provided content for display on display unit 100 via network 206 and/or to ATM apparatus 10.

The processor 412 may be embodied in a number of different ways. For example, the processor 412 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 412 may comprise a plurality of processors. The plurality of processors may be in operative communication with each other and may be collectively configured to perform one or more functionalities of the backend apparatus 204 as described herein. The plurality of processors may be embodied on a single computing device or distributed across a plurality of computing devices collectively configured to function as the backend apparatus 204. In some example embodiments, the processor 412 may be configured to execute instructions stored in the memory 414 or otherwise accessible to the processor 412. As such, whether configured by hardware or by a combination of hardware and software, the processor 412 may represent an entity (e.g., physically embodied in circuitry—in the form of processing circuitry 410) capable of performing operations according to embodiments of the present invention while configured accordingly. Thus, for example, when the processor 412 is embodied as an ASIC, FPGA or the like, the processor 412 may be specifically configured hardware for conducting the operations described herein. Alternatively, as another example, when the processor 412 is embodied as an executor of software instructions, the instructions may specifically configure the processor 412 to perform one or more operations described herein.

In some example embodiments, the memory 414 may include one or more non-transitory memory devices such as, for example, volatile and/or non-volatile memory that may be either fixed or removable. In this regard, the memory 414 may comprise a non-transitory computer-readable storage medium. It will be appreciated that while the memory 414 is illustrated as a single memory, the memory 414 may comprise a plurality of memories. The plurality of memories may be embodied on a single computing device or may be distributed across a plurality of computing devices collectively configured to function as the backend apparatus 204. The memory 414 may be configured to store information, data, applications, instructions and/or the like for enabling the backend apparatus 204 to carry out various functions in accordance with one or more example embodiments. For example, the memory 414 may be configured to buffer input data for processing by the processor 412. Additionally or alternatively, the memory 414 may be configured to store instructions for execution by the processor 412. As yet another alternative, the memory 414 may include one or more databases that may store a variety of files, contents or data sets. Among the contents of the memory 414, applications may be stored for execution by the processor 412 in order to carry out the functionality associated with each respective application. In some cases, the memory 414 may be in communication with one or more of the processor 412, user interface 416, communication interface 418, service delivery controller 420, or data tracking controller 422 via a bus(es) for passing information among components of the backend apparatus 204.

In some example embodiments, the backend apparatus 204 may include a user interface 416. However, in some example embodiments, aspects of the user interface 416 may be limited, or the user interface 416 may be eliminated entirely. In embodiments wherein the backend apparatus 204 includes a user interface 416, the user interface 416 may be in communication with the processing circuitry 410 to receive an indication of a user input at the user interface 416 and/or to provide an audible, visual, mechanical or other output to the user. As such, the user interface 416 may include, for example, a keyboard, a mouse, a joystick, a display, a touch screen display, a microphone, a speaker, and/or other input/output mechanisms.

The communication interface 418 may include one or more interface mechanisms for enabling communication with other devices and/or networks. In some cases, the communication interface 418 may be any means such as a device or circuitry embodied in either hardware, or a combination of hardware and software that is configured to receive and/or transmit data from/to a network and/or any other device or module in communication with the processing circuitry 410. By way of example, the communication interface 418 may be configured to enable the backend apparatus 204 to communicate with one or more ATM apparatuses 10, one or more mobile devices 208, one or more user terminals 210, content servers 212 and/or other computing device(s) via the network 206. Accordingly, the communication interface 418 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the processor 412 (or the processing circuitry 410) may be embodied as, include, or otherwise control a service delivery controller 420. As such, the service delivery controller 420 may be embodied as various means, such as circuitry, hardware, a computer program product comprising computer readable program instructions stored on a computer readable medium (for example, the memory 414) and executed by a processing device (for example, the processor 412), or some combination thereof. The service delivery controller 420 may be capable of communication with one or more of the memory 414, user interface 416, communication interface 418, or data tracking controller 422 to access, receive, and/or send data as may be needed to perform one or more of the functionalities of the service delivery controller 420 as described herein. In some example embodiments, the service delivery controller 420 may be configured to control operation of the communication interface 418. Thus, for example, where the service delivery controller 420 is described to cause data to be sent to another computing device, such as to an ATM apparatus 10, mobile device 208, user terminal 210, and/or the like over the network 206, it will be appreciated that the service delivery controller 420 may cause the data to be sent by controlling the user interface 416 to send the data.

In some example embodiments, the processor 412 (or the processing circuitry 410) may be embodied as, include, or otherwise control a data tracking controller 422. As such, the data tracking controller 422 may be embodied as various means, such as circuitry, hardware, a computer program product comprising computer readable program instructions stored on a computer readable medium (for example, the memory 414) and executed by a processing device (for example, the processor 412), or some combination thereof. The data tracking controller 422 may be capable of communication with one or more of the memory 414, user interface 416, communication interface 418, or service delivery controller 420 to access, receive, and/or send data as may be needed to perform one or more of the functionalities of the data tracking controller 422 as described herein. In some example embodiments, the data tracking controller 422 may be configured to control operation of the communication interface 418. Thus, for example, where the data tracking controller 422 is described to cause data to be sent to another computing device, such as to an ATM apparatus 10, mobile device 208, user terminal 210, and/or the like over the network 206, it will be appreciated that the data tracking controller 422 may cause the data to be sent by controlling the user interface 416 to send the data.

In some example embodiments, the ATM transaction services may be supported by the backend apparatus 204 (e.g., by the service delivery controller 420). For example, the backend apparatus 204 may be configured to provide transaction processing services. In this regard, the ATM service controller 320 may be configured to cause the ATM apparatus 10 to send transaction information (e.g., a card number, cardholder data, requested transaction information, and/or the like) to the backend apparatus 204 to enable the backend apparatus 204 to process a user-requested ATM transaction.

In some example embodiments, content that may be presented to a user of the ATM apparatus 10 may be pre-loaded on the ATM apparatus 10. For example, content may be physically uploaded to the ATM apparatus 10 on-site and stored in the memory 314. Additionally or alternatively, content may be provided to the ATM apparatus 10 by the backend apparatus 204 (e.g., under control of the service delivery controller 420) over the network 206 and stored in the memory 314.

In some example embodiments, content that may be presented to a user of the ATM apparatus 10 or display unit 100 may be delivered on-demand to the ATM apparatus 10 or display unit 100 over the network 206 by the backend apparatus 204, such as under control of the service delivery controller 420. Accordingly, in some example embodiments, the service delivery controller 420 and ATM service controller 420 may work cooperatively to present advertising.

In some example embodiments, content or advertising may be presented prior to initiation of an ATM transaction on the transaction display 110 or may be continuously displayed on display unit 100 for all viewers. Content or advertising presented may, for example, comprise a splash screen, screen saver, rolling content, a still image, video, audio, text, and/or the like that may be presented to a user initiating an ATM session or another viewer. In some example embodiments, content or advertising may also be printed on decals, vinyl wraps, and/or the like that may be disposed upon an identification signage 130 of ATM apparatus 10.

In an embodiment, the same content may simultaneously be displayed on display unit 100 and transaction display 110. Alternatively, different content may be displayed on display unit 100 and transaction unit 110. In still another embodiment, simultaneous content may be interrupted on one display and continue on another. For example, if display unit 100 and transaction unit 110 are displaying the same content and a user wishes to engage with ATM apparatus 10, the content on transaction unit 110 may be suspended during the ATM transaction while it continues on the display unit 100. In this regard, presentment of content may continue for viewers of display unit 100 even where ATM apparatus 10 is in use.

In another embodiment, display unit 100 and transaction unit 110 may display separate content simultaneously and may coupled to the same or different networks. In this manner a user of the ATM apparatus 10 may receive targeted content or advertising on transaction unit 110 while the general passersby receive alternative general content. Such example embodiments may used to provide a surcharge-free ATM experience.

In some example embodiments, content may resume after completion of a transaction. In an embodiment, a user of ATM apparatus 10 may be presented with follow on content in the form of a printed advertisement. For example, in an embodiment, a printed advertisement for a product or service may be presented via data entry terminal 120. Additionally or alternatively, the printed content may comprise a coupon, promotional offer, and/or the like that may be redeemed for a discounted product or service. For example, the printed content may include a barcode that may be presented to a vendor for a discounted product or service. Additionally or alternatively, as another example, the printed content may include a web address, code, and/or the like that may be used online to obtain a discounted product or service. In some example embodiments, content that may be presented after completion of a transaction may be delivered to a user electronically (e.g., to a mobile device 208 that may be associated with the user), such as via email, text message, and/or the like.

In some example embodiments, non-ATM apparatuses comprising display units 100 may be configured to integrate with the network 206 to facilitate the promotion of products services, and/or other activities that may be performed on kiosk or ATM apparatuses in accordance with various example embodiments.

In some embodiments, display units 100 may be integrated with the network 206, and may be placed at various locations within a facility or on the kiosk 10 as illustrated in FIG. 1 As an example, display units 100 may be integrated into seats, booths, tables, and/or other furniture within a bar or restaurant. As a another example, display units 100 may be distributed throughout an office or apartment building, in stores, elevators and malls or in general areas that are may or may not be accessible 24 hours a day.

Accordingly, it will be appreciated that in some example embodiments, a variety of computing devices and display units 100 may be integrated with the network 206 to enable the display of content, and the promotion of products and services in accordance with some example embodiments.

Due to the placement and access to kiosk 10 and display units 100 displaying content on display unit 100 may not always be practical or possible. This is especially true in areas where the kiosk 10 is not operational and or exposed 24 hours a day 7 days a week. Unlike traditional open air signage, display unit 100 will not always be accessible to the public. Accordingly, it is difficult to compute and estimate the exposure and schedule effectively and economically, the value of such a display.

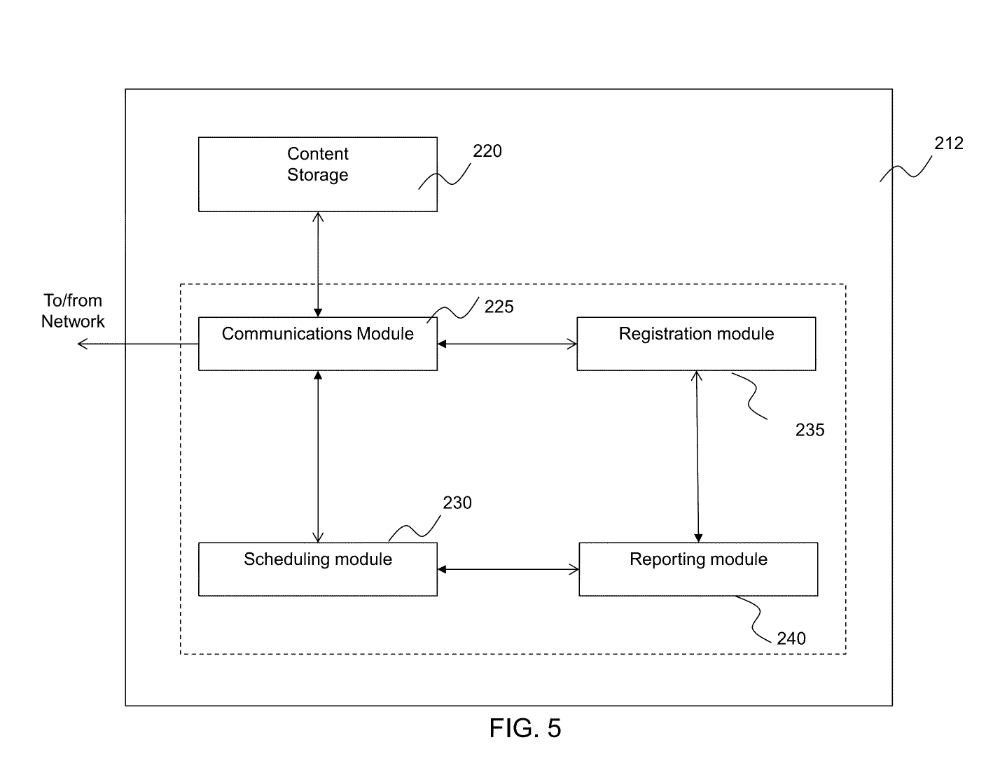

FIG. 5 depicts an embodiment of content server 212. Content server 212 comprises, content storage 220, communications module 225, scheduling module 230, registration module 235, and reporting module 240. Content server 212 may communicate with network 206 via wired or wireless communication. Content server 212 may be part of backend apparatus 204 or may be a stand alone component.

Communications module 225 may send data to and receive data from any of the ATMs 10 or display units 100 connected to a network like network 206. Communications module 225 may communicate on any open or closed network, any WAN or LAN and through any means, such as wired or wireless. Communications may take any standard form and may be synchronous, asynchronous, packetized, etc. Communications between content server 212 may be over one or more local or wide area networks and may include communications over the internet. Content storage 220 may be part of content server 212 or may be external to content server 212. Content storage 220 may house content or may be an index of content stored elsewhere. Content may be stored in any form of memory device and may include physical memory in content server 212 or may be remote cloud storage.

Content server 212 may house a CMS/Scheduler 230, which is central to the network and the distribution of content. In an embodiment, the CMS/Scheduler helps manage the inventory of ATMs, ATM displays, and display units. In an embodiment, it manages content such as premium content or advertisements shown on the network, manages the scheduling of content or ads, interfaces with 3rd party remnant providers, serves as the master database and provides the reporting services. Scheduling module 230 in an embodiment, is utilized to maintain and schedule display of content from content storage 220. Scheduling module 230 may maintain database and records of all available display units and ATMS and will schedule the displaying of content to maximize the required CPMs. Scheduling module 230 may be responsible for determining time slots for content and may prioritize content display based on price and/or availability. Initially, scheduling module 230 may receive information from registration module 235. Registration module 235, in an embodiment may communicate via communications module 225 over network 206 to obtain original information about each kiosk or ATM 10 and from each display unit 100 or from stand alone display units 100. Initial registration information may include the location information for the ATM or the stand alone display unit 100. ATM and display unit locations should be accurately identified and are unique, so information may be necessary upon location entry to distinguish one ATM or display unit from another. Accordingly, simple address information or building name may be insufficient. In an embodiment, the required information may include, venue name, unique address, venue type, decor & atmosphere. In an embodiment it is also necessary to include amount of monthly foot traffic. In addition, registration module 235 requires information on the availability of the ATM and/or display unit 100, such as days of the week and hours of operation.

Reporting module 240 may collect information about each ATM and/or display unit 100 which may include reports of displayed content, availability, maintenance, ATM access, etc. In operation all communications with content server 212 may be through communications module 225. Once an ATM and/or display unit 100 are registered with registration module 235, information is made available to the scheduling module 230. A potential advertiser or content provider with specific content may request a specific number of impressions and/or content displays within a specific area or location. Scheduling module 230, based on the registration information will determine which display units 100 within the system meets the specific advertiser's criteria. Scheduling module 230 will next determine available time slots for displaying the content to satisfy the advertiser's request. The advertiser may upload the content to content storage 230 or provide addressing information for the content to content server 212. After the content is made available and the schedule has been set to satisfy the number of requested impressions, Content server 212 will communicate via network 206 and push the required content to the ATMs and/or display units 100. Reporting module will record each time the desired content has been displayed and on which display's and may communicate that information on a scheduled basis or when requested. This information may be reported back to the requesting party via reporting module 240.

In an embodiment, content server 212 contains a reporting module 240. Reporting module 240 may generate actual reports in a specified format or in an embodiment may output data to be imported into a report format. Reports are only limited by the data that can be ingested and collected in the system. Reports may be based on the status and associations of the User. For example, if a client wants a revenue report, s/he will only see the revenue generated by the ATMs associated with that client and may not have access to a delivery report. If an advertiser wants to see a delivery report, they will see only the ads they are associated with, and not have access to a Revenue Report. Meanwhile, in an embodiment, super-users may have total access to all reports, and may have additional criteria, filters and inputs.

In some embodiments, content may be targeted and/or personalized. When displayed on the transaction display 100, it may even be targeted to the specific user. For example, in an embodiment, content may be provided to a display unit 100 and an ATM apparatus 10 based at least in part upon a location of the ATM apparatus 10 and display unit 100. In this regard, ATM apparatuses 10 with display units 100 deployed on the network 206 may be divided into a plurality of location-dependent groups based at least in part upon their respective locations. ATM apparatuses 10 and display units 100 may, for example, be assigned to location-dependent groups based at least in part upon a physical region in which they are deployed. Thus, for example, an ATM apparatus 10 and display unit 100 may be assigned to a group based at least in part on a zip code, city, state, geographic region, and/or the like in which the ATM apparatus 10 and display unit 100 may be deployed. Additionally, or alternatively, ATM apparatuses 10 and display unit 100 may be assigned to location-dependent groups based at least in part on a type of location in which they are deployed. For example, ATM apparatuses 10 and display units 100 deployed in night clubs, sports arenas, shopping malls, offices, transportation stations, and/or the like may each constitute a separate location-dependent group. In some example embodiments, an ATM apparatus 10 and display unit 100 may be assigned to a location-dependent groups based at least in part on both a physical region of deployment and a type of location within which the ATM apparatus 10 is deployed.

In an embodiment, a location-dependent group may be associated with a set of consumer demographics which may, include a location, age range, sex, probability of a certain race, spending power, and/or other demographic factors that may be associated with the average user of an ATM assigned to the location-dependent group. Accordingly, display unit 100's targeted to a demographic group that may be associated with a location-dependent group of ATM apparatuses 10 may be provided to display unit 100s and ATM apparatuses 10 within the location-dependent group. Thus, for example, content or advertising that may be presented on a display unit 100 in Los Angeles, Calif. may be different from content or advertising that may be presented on a display unit 100 located in Peoria, Ill. due to the difference in consumer demographics between Los Angeles and Peoria. In another embodiment, content or advertising that may be presented on a display unit 100 located in a night club frequented by an average age range of 21-30 may be different from content that may be presented on a display unit 100 located in a suburban shopping mall frequented by 35-50 year old soccer moms. Accordingly, in some embodiments, a content provider may have its content selectively delivered to one or more siloed groups, based at least in part on the advertiser's target demographic.

In some embodiments, content presented on display unit 100 may be targeted to a current user of the ATM apparatus 10. In this regard, a user of the ATM apparatus 10 may be identified based at least in part on a card (e.g., bank card, credit card, debit card, or the like) presented by the user to initiate an ATM transaction and/or other indication of the user's identity that may be provided in order to initiate an ATM transaction.

In some embodiments, display unit 100 may enable a user to make purchases and/or reservations via the display unit 100 or ATM 10 related to the content displayed on display unit 100. The purchases/reservations may, for example, be conveyed to the vendor by the ATM service controller 320 via any communication link by which the ATM apparatus 10 and a vendor's computing device may be in communication, such as via the network 206, via a wired communication link, via a wireless communication link (e.g., Bluetooth, WLAN, IR, RF, and/or the like), and/or the like.

In some embodiments, the content displayed on display unit 100 may be selected to enable a user to purchase location-based offers from kiosk/ATM 10. The location-based offers may be limited time offers, which may periodically change. For example, the location-based offers may comprise “daily deals” that may change on a daily basis. Customers may be able to buy a limited time location-based offer up until the designated time that a vendor wants to end the special. In some embodiments, location-based offers that are redeemable for food, services, and/or the like may be redeemed within a designated time frame (e.g., by a designated expiration date/time) that may be imposed by the vendor.

A location-based offer may be unique to a particular location(s) of display unit 100. In this regard, a location-based offer in accordance with some embodiments may only be purchased by visiting a particular ATM location(s) through which the offer may be offered for sale.

Electronic advertising and displaying of content is generally bought/sold on a cost per thousand impressions or CPM (“Cost Per Mil”) basis. When this is done for mobile devices or websites, an impression is easily defined, i.e., one ad displayed on one user device equals one impression. On a passive unit, such as a display kiosk or display unit 100 this is more complicated. It is not exactly known how many people have seen the content or advertising or if any one has seen it. Because of this, impression counts become more of a calculation based on probabilities of viewership attributed to a number of values, including foot traffic and dwell time, rather than a direct count. When the passive unit is in a location, such as on a street, it may be possible to count potential viewers during a given period of time. The value of the location is then calculated using a pricing index developed by a provider such as the Nielsen® company. When a display unit, either one associated with an ATM, indoor kiosk, or stand alone display, is valued, CPM must be adjusted based on the time the unit is available to display content.

For example, a display unit placed within a mall may only be accessible between the hours of 10 a.m. and 8 p.m. therefor adjustment must be made to any standard CPM attributed to that geographic location. The first adjustment necessary to the current CPM calculation for a particular kiosk, ATM 10 or display unit 100 must account for each unit's daily available hours in the core impression calculation. This allows for a greater level of specificity in the CPM calculation.

Next, the total number of impressions and the available impressions are calculated. Total Impressions equals the sum of each unit over time of a specific ecosystem, based on a set of criteria.

For example, it may be known that in a specific zip code over a 30 day range there are 100,000 number of impressions available. In an embodiment of the present disclosure, the system could determine the daily impression count for each of the display units 100 within the entire zip code and then sum them all. If however, the geographic footprint is changed to something smaller over the same date range, then the display units 100 in the ecosystem would change. It would be expected that only a few of the display units from the first overall set would constitute the total impressions of the small reduced footprint.

Based on this information the number of available impressions can be calculated before scheduling any content displays. Available impressions as used herein is the difference between the total impressions and the impression count introduced by the ad schedule, i.e., scheduled impressions. That is, Available Impressions=Total Impressions−Scheduled Impressions (A=T−S) or

A=τ_{0->n}Σ_{0->t}NpSₙₜ*(Σ_{0->n}DTSₙ+ALSₙ)−Σ_{0->n}Σ_{0->t}Sₙₜ

where A=Available Impressions; T=Total Impressions; S=Scheduled Impressions; t=time; n=Number of ATMs with Display units or stand alone display units; I=Impressions per Ad; NpS=Notices Per Second; DTS=Dwell Time in seconds; ALS=Average Ad Length in seconds; SDD=Seen During Dwell Time (NpS*DTS); and NpSp=Notices per Spot (NpS*ALS).

Impressions/ad is calculated from a known source such as from Nielsen®. I=SDD+NpSp (Impressions/Ad=Seen During Dwell Time+Notices per Spot). Therefore the Total impressions are the impressions (I) available on all display units (n) that apply to a certain geographic area (whether the geography is specifically requested, like a zip code, or the area defined by demographic or psychoraphic requirement) over the time those display units are operating.

T=Σ_{0->n}Σ_{0->t}(SDDₙₜ+NpSpₙₜ)

The total can then be expressed as:

T=Σ_{0->n}Σ_{0->t}SDDₙ+Σ_{0->n}Σ_{0->t}NpSpₙₜ

This translates into the following:

T=Σ_{0->n}Σ_{0->t}(NpS*DTS)ₙₜ+Σ_{0->n}Σ_{0->t}(NpS*ALS)ₙₜ which can be represented as

T=Σ_{0->n}Σ_{0->t}NPSₙₜ*(Σ_{0->n}(DTSₙ+ALSₙ)

ALS is related to the Ad content, so it is a constant.

T=Σ_{0->n}Σ_{0->t}NpSₙₜ*(Σ_{0->n}DTSₙ+ALSₙ)

Accordingly, given the Total impressions, the available impressions are the Total impressions minus the Scheduled impressions, and expressed in the following manner:

A=T−S (Available Impressions=Total Impressions−Scheduled Impressions) or

A=Σ_{0->n}Σ_{0->t}NPSₙₜ*(Σ_{0->n}DTSₙ+ALSₙ)−Σ_{0->n}Σ_{0->t}Sₙₜ

When a client requests that their content/advertisement reach a certain impression count, they enter their geographic or demographic criteria, the starting and ending date that the line item (or Ad) should run and how many impressions they wish to reach in that time period. Based on this information, in an embodiment, the system calculates the number of venues that meet their geographic/demographic request. Then, using the information regarding each location and the length the Ad should be seen, it may determine the number of times that Ad should be displayed, per day, per unit.

In an example, a user may wish to schedule content/advertisement 100 CPM (100,000 impressions) to be displayed in a given zip code over a 30 day range. First, the total impressions needs to be obtained for use in the scheduling calculation. Next the Available Impressions needs to be calculated by removing the impression count lost due to scheduling, i.e., times when the displays are not available because other content is scheduled or because the displays are in inaccessible areas or the displays are off line. For example, if Ad1 is schedule to be played within the requested area then the available impressions for Ad2 over the same date range is reduced by the number of impressions used by Ad1. That is, Ad1 consumes a specific fraction of the devices and their impressions. The same situation may occur if Ad2 was attempted to be scheduled within the same geographic area, over a 30 day range, but 10 days later than the Ad1. Available Impressions might be skewed, e.g, shifted in time because of the overlap, (provided nothing else has been scheduled) toward the latter 10 days. Further, the total available is reduced by display units not being available for every time slot.

In an embodiment, a scheduling calculation and distribution smoothing may be used. Effectively, for the #of plays/unit/day (P) the system may round up (Requested Impressions/Total Impressions) to ensure all impressions are played.

In an embodiment, in the calculations of the number of Plays per Day (PpD), the floating point number is converted to an integer and always rounded up. This guarantees delivery of the impressions and most of the time will result in over delivery if all PpDs are filled on all devices. Except in the case where a location is not open, the target is to provide the same number of plays per day per unit. Locations where display units 100 and ATM 10s are located keep their own hours and those hours may vary by day. In an embodiment, each location will receive the same number of PpD, but that number will comprise a wildly different percentage of inventory. Accordingly, in order to maximize the impressions, the Ads/content is assigned in a way that the location/days are allocated from the highest location/day block count and Nps (Notices per second) to the lowest, with the sum of impressions being checked during each allocation.

In an embodiment, the #of Plays/unit/Day is an integer designed to exceed the Requested Impression count when summed together. In order to satisfy the number of requested impressions, the content is assigned a set number of times to be played/day/each unit/day. The scheduled information is then scheduled to be disseminated to the display units 100 that have the longest open hours to smallest open hours. In this way it is assured that the maximum number of ads may be displayed per unit.

For example, the time slot position of each ad (A) throughout the day may be computed by utilizing the following:

Time slot=((hours Available/(P))*(A))−((hours Available/(P))/2)

For example, if there are 200 display units in a geographic area that have varying availability and hours over the 30 days that the 100 CPM ad is to be scheduled, the entire ecosphere would be ordered by device by day, with the largest hours and the earliest days toward the front. Assuming that the Total Impressions for that ecosphere is 7400 impressions, which would require 14 plays per unit per day. Then, if on Day 1 a device is available 14 hours, from 7:00 am to 9:00 pm the content/ad would be scheduled starting at 7:30:00 am and attempt to be scheduled every hour on the exact ½ hour until 8:30 pm, accounting for 14 plays for that day. By the time the system approaches the display unit with the smallest and latest day availability, the probability is that the impression count would be reached before all the time slots are allocated for the display units with less available hours.

In an embodiment, in the event of a scheduling conflict the scheduler of the present disclosure adjusts the content display timing. It is understood that other scheduling scenarios may be used without departing from the spirit of the disclosure. In an embodiment, since ads/content have a finite time interval, each day's available time may be viewed as a linear sequence of discreet increments of blocks, wherein each block is that time interval, such as a 15 second increment. Ads are typically aligned in 15 second increments, i.e., 15, 30, 60, seconds. Since two ads can not occupy the same block at the same time a scheduling conflict would arise if two ads were seeking the same number of impressions within the same period on the same number of displays. In an embodiment, the scheduling algorithm may determine that the desired ad should go into a block (or timeslot) occupied by a previously scheduled ad. When this occur, the conflict may be resolved by moving block-by-block, sometimes forward in time, sometimes backwards in time, from the conflict. In an embodiment, the initial direction for each iteration is chosen at random, but then toggles between forward and backwards for each subsequent iteration and conflict.

For example, Ad1 and Ad2 both want the same number of impressions within a 30 day period in the same geographic area. Assuming that the total impressions available for 200 display units in the geographic ecosphere is 7400 impressions, which requires 14 plays per unit per day. If on day 1, display unit 100 may be available for 14 hours, from 7:00 am to 9:00 pm. As previously explained, the scheduler will attempt to schedule the ad placement starting at 7:30:00 am and attempt to be scheduled every hour on the exact ½ hour until 8:30 pm, accounting for 14 plays for that day. On each attempt, however, it will see a conflict with the other similarly scheduled ad. In an embodiment, upon the first conflict the system may randomly decide to go back a time slot. Additionally and/or alternatively, it may go back any number of slots, or may go forward 1 or a random number of time slots. Once the determination to move time slots is made, on the next scheduled insertion, the ad may be placed in a similarly offset time slot or may be moved ahead of the other scheduled ad a similar number of offset slots. In an embodiment, if there are no other ads to present conflicts and the ad is a 15 second ad, then the ad will be placed in schedule, to be inserted at: 7:29:45 am, 8:30:15 am, 9:29:45 am . . . 8:30:15 pm.

Scheduling of content may take place directly, through an agency or through a sales representative. Scheduling and purchase of impressions may be done online directly with, content providers or through a third-party agency. Those wishing to display content must identify the locations and the desired number of impressions sought. Content scheduling and display may be based on desired impression count+time period. For example, the desired number of impressions for a particular time are entered, e.g. 15,000 impressions in a specific zip code over a week (Monday-Sunday). Once an order is placed, in an embodiment, the present system may determine the budget+CPM+Flight Date. For example, if the desired budget and cost per thousand impressions for a particular time is entered, e.g. $15,000 and a $10 CPM (=1,500,000 impressions) in zip code, 10011, over a week (Monday-Sunday), then the system has to determine if there are a total number of impressions available to meet the need, if the available impressions are sufficient to meet the need, the system will determine if all the required impressions can be scheduled. In an embodiment, if, at any point, any of these queries fail, the user/content purchaser will be informed and then prompted to change the location, the impression count or the date range, with a default of the date range chosen and the days pushed out. Once a successful combination of price, total impressions, region and date range are selected, the User may be asked to commit and complete the order. In some embodiments, this requires the addition of payment information in the form of a purchase order number and/or credit card information. In an embodiment, once scheduling is resolved, a creative can be selected from existing creative inventory or uploaded to the content sever 212.

In an embodiment, the scheduling module 230 creates a “playlist” of scheduled objects or content. The playlist may comprise a series of blocks, in order of play, that are equivalent to actual 15 second increments when the display unit is on and serving to an active audience. In an embodiment, the play list is a series of appended content to create a single file that plays at the allocated time displaying the content in the scheduled order. In another embodiment, the playlist is an index that allows the content server 212 to locate and stream the content during the allotted time slot.

In an embodiment, each object in the playlist will be a series of blocks, from the push time forward. Such information may be arranged in a database, flat file, script file or any other format. It may contain an ad ID, the pointer to the creative, the number of blocks the content takes up (1=15 sec, 2=30 sec, etc.) and the position of the block in the object. Any changes require a new playlist generated. In an embodiment, open blocks may be filled by a bulk request ads from a bulk advertiser such as VistarMedia, house ads or host ads. House ads or ads for the party hosting the ATMs 10 or display units 100 may be inserted into the ad inventory and may be set based on a percentage of total ads displayed and/or available.

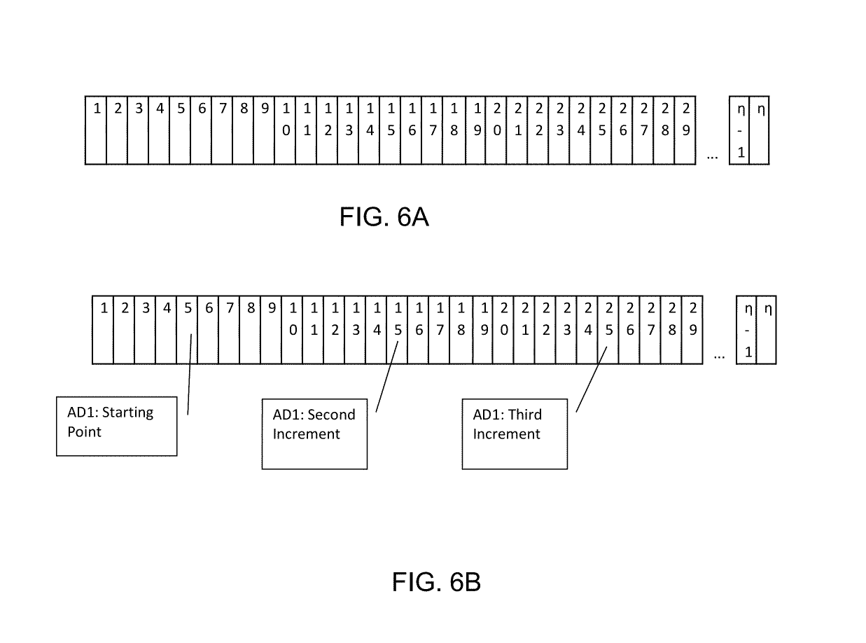

In an embodiment, once the plays per day (PpD) are established, the Ad needs to be distributed throughout the day. In an embodiment, this is accomplished by converting the business day into a discreet set of “blocks”, each representing 15 second intervals. FIG. 6A represents a day broken into its constituent blocks.

The first block (1) is the “zero-hour” that the location is open (i.e., that the display unit 100 is available for viewing) for a certain day/date and the ηth block is the last 15 seconds before a location closes. Therefore, there are 240 blocks in any given hour (60 minutes*4 blocks/minute=240 blocks). For example, a business that opens at 5:30 in the morning and closes at 11:00 pm at night is open for 17.5 hours, and therefore has a potential schedule of 4200 blocks (240 blocks/hour*17.5 hours=4200 blocks).

In an embodiment, once the day is broken up into numeric blocks, then the first step is to try to evenly distribute a selected ad throughout the day. In an embodiment, this is accomplished by simply taking the number of plays per day per unit, on a unit by unit basis, and dividing the maximum number of blocks (η) by the numeric value represented by PpD. This number is the increment of each ad play. For example, in order to reach the appropriate impression count, Ad1 has to play 420 times/day/machine. The increment would therefore equal 10. Increment=(η)/(PpD)=4200/420=10. So in an embodiment, the first instance of Ad1 could be placed in the schedule starting at position 1 each time, at the first increment, or something else. If every Ad started at block 1, then every Ad would immediately be in conflict. Since no two Ads can be shown at the same time, every Ad but the first one would have to be moved. In an embodiment, the Ad could start at its first increment, in the example it would be block 10. While this may reduce conflict, most Ads would have a tendency to skip the earliest increments and those earlier time slots would not be effectively utilized.

FIG. 6B depicts the biasing of an Ads starting slot based on an embodiment of the present disclosure. In this embodiment, the starting block is biased by a percentage of the increment. In an embodiment, ½ of the increment is used to bias the starting point. In the example ½ of the increment would be 5, therefore, Ad1 would be scheduled to start at slot 5, which if the location was available starting at 5:30 a.m. Ad1 would first play at 5:31:00 am. Subsequent plays of Ad1 would then be placed in the slot represented by every increment afterwards, slot 15, slot 25, etc.

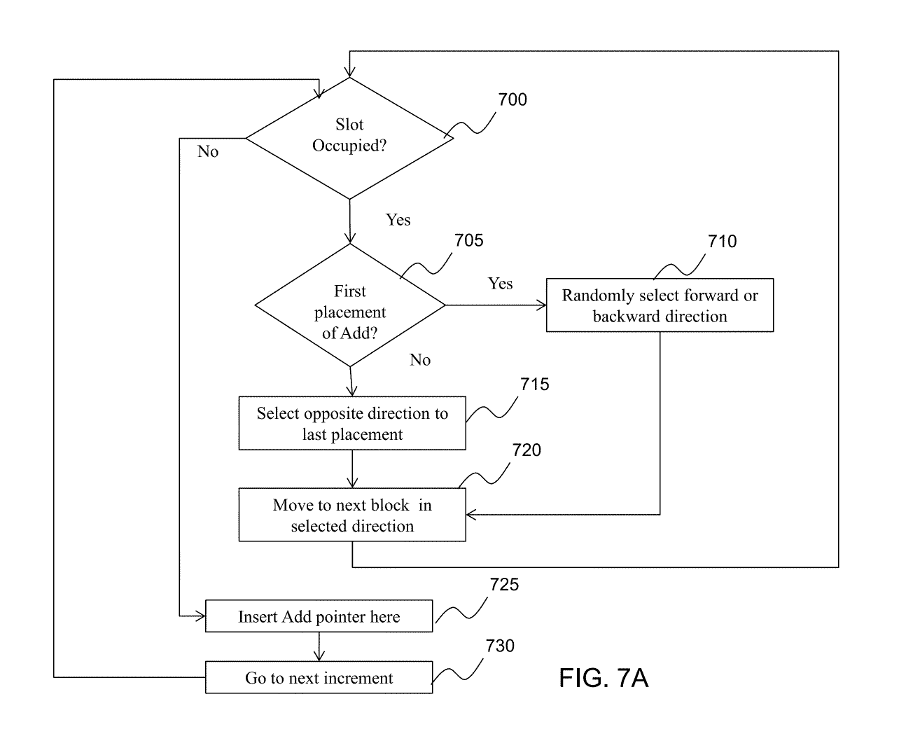

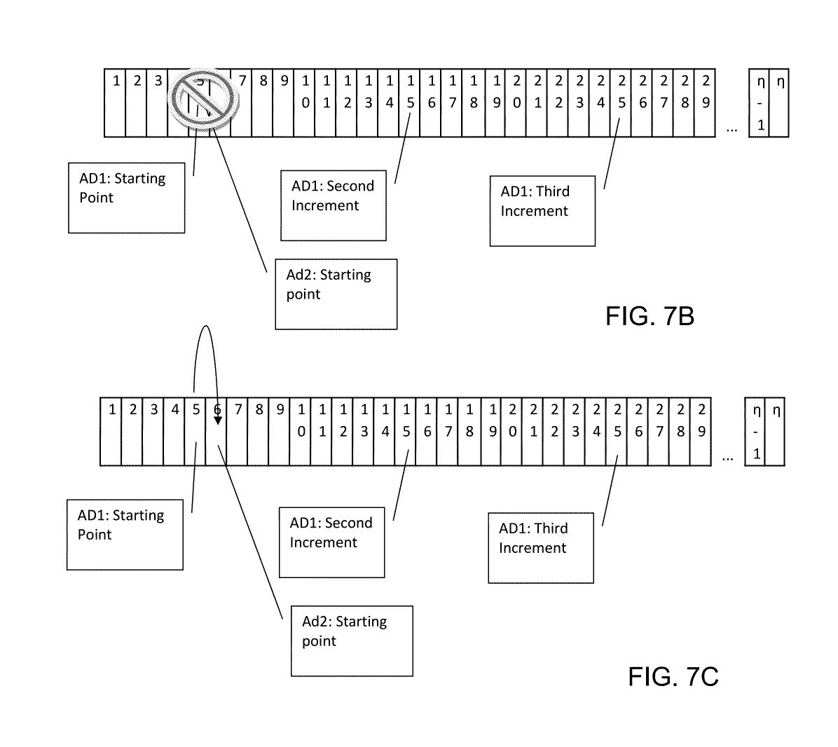

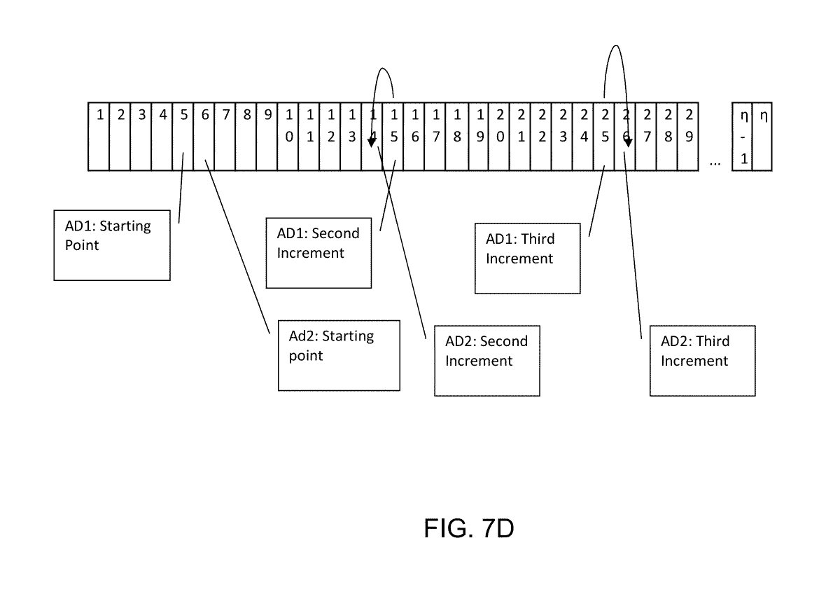

Because each location schedule for a day can be involved in many Ad campaigns and have many line items (Ads), it will be apparent to those skilled in the art that there quickly becomes a chance for conflict to arise as these ads may want to occupy the same block. Even if the increments vary from one Ad to the other, there is a high probability that some multiples may result in the same position. FIG. 7A depicts the flow for conflict management resolution of ads of a single length. At step 700, the current schedule is reviewed and the location/date of interest are checked to see if an Ad has already been scheduled. If the slot is available, the system jumps to step 725 and the ad selector pointer is inserted and the ad scheduled. If however, the slot is already occupied by a previously selected Ad, the process proceeds to step 705. At 705, if it is the first placement of the Ad, i.e., the first slot, then a random decision to increment or decrement i.e., toggle, the slot selection is made and noted at step 710. A positive toggle or incremental increase represents a forward movement and a negative toggle or decrement represents a backward movement on the slot spacing.

If it is not the first placement of the selected ad, then at step 715, the opposite direction or toggle is selected and the pointer moves to the next slot in the desired direction at step 720. At this point, the process returns to step 700 to determine if the newly selected block is occupied. If it is not, the process proceeds to step 725, the ad is inserted and the process proceeds to step 730 to place the ad at the next location. In this manner, all slots for a particular ad are allocated along a linear slot allocation.

FIGS. 7B-7D illustrate an example of the block conflict management resolution. In an embodiment, in order to reach the appropriate impression count, Ad2 has to play 420 times/day/display, this is the same as Ad1 illustrated in FIG. 6B, which for this example has already been scheduled. The increment would be 10 (increment=(η)/(PpD)=4200/420=10) and the biased starting point would be 5. As seen in FIG. 7B this would result in a conflict at every interval, i.e., 5, 15, 25, etc. FIG. 7C depicts the conflict management resolution. As seen, Ad2 instead of starting at slot 5 is moved to slot 6, which in the example is open. As seen in FIG. 7D all subsequent increment slots are selected by toggling up or down one block in a back and forth direction. Ad2 starts in slot 6 and at subsequent intervals rather than simply incrementing the required 10 slots from the original starting point, at the second increment since the first placement moved forward to slot 6, the second placement moves back to slot 14. Subsequently, at the third increment, Ad2 is moved forward again from original slot 25 to incremented slot 26. This process would continue until all the plays/day were satisfied.

In an embodiment, it was determined that if an ad is always advanced in a single direction, i.e. always forward, than over time the system would heavily load the end of the day and leave the beginning of the day very open. Accordingly, as seen in FIG. 7B, even though the actual starting point has moved, in an embodiment, the calculated value is used as the base value starting point when considering the next increment. As with the first block (5), block 15 (representing 5:33:30 am) is occupied by Ad1. Since the conflict manager already looked forward, the system will now look back for the next placement.

It is understood, that by advancing forward, the system will eventually reach block η at which point it will wrap around to block 1. Accordingly, given enough Ads the system will eventually fill the early part of the day but in a very inefficient manner. While selecting a single toggle direction may mitigate this effect, it very quickly results in the same problem. By toggling back-and-forth the system of the present disclosure more efficiently fills the allocated time slots. In an embodiment, a random generator may be used, however, for ease of programming, toggling directions is easier to implement.

In an embodiment, the content/Ads are limited to uniform 15 second increments. The schedule and block conflict implementation in such an embodiment is straight forward. However, in an embodiment, the system must deal with ads that are of varying lengths. Since Ads play in a sequence (and not at a specified time) if an Ad was 10 seconds in a block, the next block would just play early and the whole schedule slide a little bit, forward. Similarly, if the Ad was 16 seconds, although if the block sequence deviated too far from the actual time, the system would periodically set the block to the appropriate one for the time, skipping or replaying certain blocks. Typically, however, Ad are 15 seconds, 30 seconds, 45 seconds or a minute in length. Scheduling ads of mixed lengths creates differing scheduling scenarios.

In an embodiment, to address these various cases, the system groups blocks together to allocate the required Ad time. In an embodiment, for a 30 second Ad two blocks are used; for a 45 second Ad three blocks; for a minute Ad four blocks; etc. Since Ad length is a key part of calculating impressions, the actual available number of impressions will change, resulting in a different PpD, but all other calculations remain the same.

In an embodiment, to address Ads of varying length, the way the distribution occurs must be revised. Initially with all uniform ads, the system looked only at the block of interest, with varying length ads, however, both the first block and the multiple subsequent blocks have to be checked for availability. This means that for a 30 second Ad, both the increment block and the increment+1 block will need to be checked. If both are free, then the Ad can be scheduled.

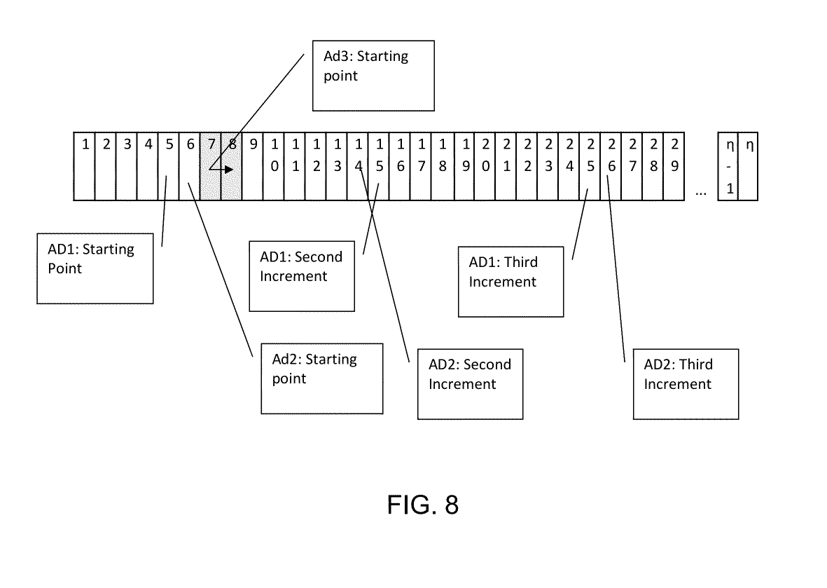

FIG. 8 depicts an initial slot allocation for a series of ads including a 30 second ad placement. To reach the appropriate impression count, Ad3, which is a 30 second Ad needs 310 plays/day/machine. The increment would therefore be 13.55 which will be rounded to an increment value of 14. Relying on the same biasing, half of 14 is 7. Accordingly, slot 7 would be the initial starting point for Ad3. Since this is a 30 second ad requiring 2 slots, both slots 7 and 8 would need to be available.

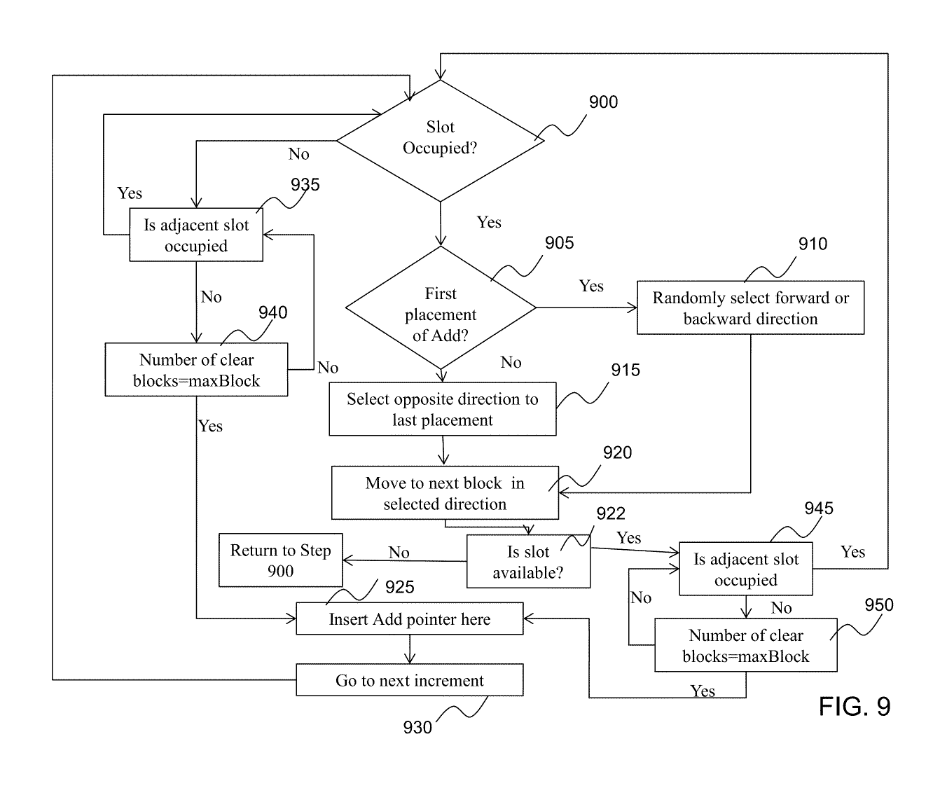

In an embodiment, multiple block Ads require block conflict management. While the fundamental rules remain the same the rules for conflicts and the rules for movement become more complex, especially because the same rules of direction still apply, i.e., toggle of +1 or −1 slot. FIG. 9 is a flow diagram of the slot placement and conflict management for ads which require multiple blocks for scheduling.

First, the Ad's playtime is divided into 15 second increments. The result is computed and stored as maxBlocks value. At step 900 as with a single block, the system determines if the desired original slot has previously been scheduled. If it is occupied, the system determines at step 905 if it is the first slot placement for the Ad. If it is the first placement, at step 910 a selection of +1 or −1 toggle to adjust is selected and stored. If it is not the first placement, then the opposite direction to the last placement is selected at step 915 and the next adjacent block is considered at step 920. At step 922 a determination is made if the slot is available. If it is not the system returns to step 900. If at step 922 it is determined that the slot is available, then the system proceeds to step 945 where it checks the adjacent slot. If the adjacent slot is occupied, the system returns to step 900. If it is available, the system determines if the number of consecutive blocks equals maxBlocks. If is does, then there is space for the ad and the pointer is inserted at step 925 and the next increment is checked at step 930. If at step 950, the number of maxBlocks is not yet met, they system returns to step 945 to consider the next adjacent block until maxBlocks is reached. If at step 900 the initial slot is not occupied the system proceeds to step 935 to check the adjacent slot. If at step 935 the adjacent slot is occupied, the system returns to step 900. If it is free, then at 940, number of consecutive blocks is compared to maxBlocks. If the number of blocks equals maxBlocks, then the pointer is inserted and the ad may be placed If not, the process continues until a series of suitable slots equal to maxBlock can be located.

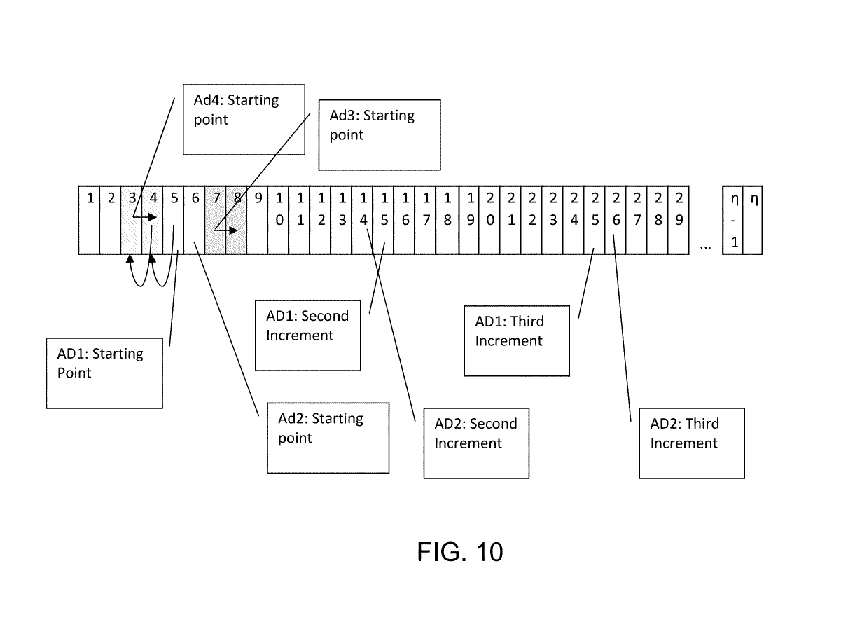

FIG. 10 illustrates the placement and the conflict manager for a second 30 second ad, Ad4 which conflicts with Ad1. In FIG. 10 Ad4 has the same 420 plays per day as Ads 2 & 3, but, like Ad3 it is a 30 second Ad. Its original starting point should be slot 5. Because of earlier placements, block 5 is occupied by Ad1. For illustration, the initial toggle is backwards, and the scheduler looks to block 4 and sees that it is unoccupied. Since Ad4 is a 30 second Ad, the maxBlock=2 (30 seconds/15 seconds), so block 3 must also be checked. Since, slot 3 is available, Ad4 is initially inserted in blocks 3 & 4 as shown in FIG. 10.

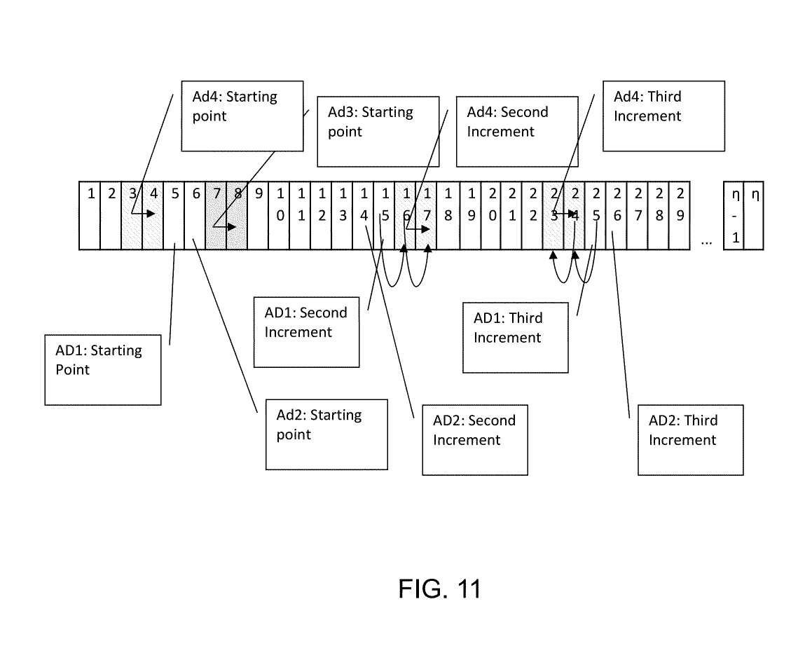

FIG. 11 illustrates subsequent slot selection for Ad4. At each increment (10) of Ad4 the same toggle rules (+1 or −1) is applied, such that the second check for Ad4 will be at slot 15 and will look forward if there is conflict. The result is that Ad4's second play will occur in slots 16 & 17 because slot 15 is occupied and the toggle is +1. The third play which should be at slot 25 is toggled back to start at slots 23 and 24.

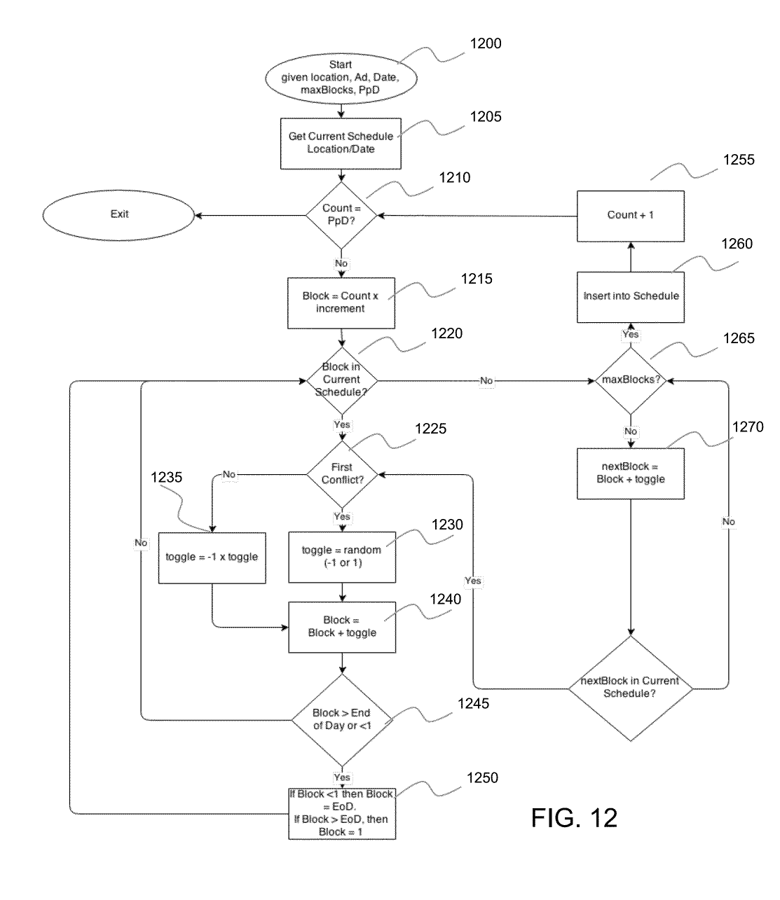

FIG. 12. Is a diagram of the system, method, and apparatus according to some example embodiments. FIG. 12 depicts the scheduling management and conflict resolution for an embodiment. At step 1200, the plays/day, the maxBlocks, the location and ad date are determined. At step 1205, the time slot schedule for a specific location is retrieved. At step 1210 the count for the scheduled plays per day for a specific ad is determined. If the PpD equals the count of times already scheduled, the system exits. Otherwise, the system attempts to schedule the Ad for display. At 1215, on the first placement of the Ad, Count equals zero and the system determines at step 1220 whether the Ad has been placed on the schedule or if this is the first placement. At step 1225, it is determined if a scheduling conflict exists. If it does at 1230 a random toggle is selected of plus or minus one slot. If no conflict exists, at step 1235, the toggle is set to a random plus or minus for the next potential conflict. At step 1240, the slot selected is the slot + and toggle applied. At 1245 it is determined if the scheduled slot exceed the allocated slots available for the day. If the block value is greater then the allotted values, the system sets the block value back to loop around for unfiled slots earlier in the timing rotation.

If at step 1220, there are no slots allocated to the present Ad, the system checks the maxBlocks count to determines if the ad will require multiple consecutive slots. If maxBlocks is not reached the ad is inserted into the schedule at step 1260 and the count for the total Plays/day is increased at step 1255. If MaxBlocks is not reached at step 1265, the next slot plus the toggle is checked at step 1275. If there is a conflict, the system proceeds to step 1225 to find the next empty slot. In an embodiment, the scheduler will proceed with this until all slots are filled and all plays per day have been scheduled.

In an embodiment, if there are empty slots in a schedule, the system will insert house adds from the provider first and, may insert ads from the landlord, or may pull ads from an ad service provider such as VistarMedia, to supply purchased ads to fill the empty slots. In an embodiment, house ads occupy a dedicated percentage of the ads. In an embodiment, house ads were between 5 and 25% of the total ads. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device storing instructions executable by a processor in the computing device. In some example embodiments, the computer program instructions of the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s).

The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an embodiment, the displaying of content on display units 100, and associated fees generated therefrom, is intended to offset the fees associated with using the kiosk or ATM 10. Accordingly, in an embodiment, ATM display units 100 are provided in proximity to already existing ATMs to offset ATM fees.

Because of the financial nature of ATM machines, communications with them are often restricted and/or limited to very specific types of communications. Accordingly, in order for the ATM to communicate with the content server 212 and/or the display unit 100 a bridge must be used between the ATM and the display units 100. The bridge acts as a translator between the network 206 and the display unit 100 and ATM 10. The bridge is required and serves as the translator between the CMS/Scheduler and the ATM.

The bridge serves to compensate for the limitations of the communications with the ATM and the RMS and existing hardware. In an embodiment, the bridge may be used for transferring inventory, scheduling and transaction log information between the CMS/Scheduler and hardware. It may break down day schedules into smaller chunks to compensate for display unit timeouts. It may be used to extract and store the content or advertising assets locally for upload to the either display unit 100 or ATM 10. It may be used to build and managing the patch.zip files, perform heartbeat/health checks on hardware and issue alerts. The bridge may be used to parse display unit log files into proof-of-play data, issue commands to the MoniView Database, set up “scheduled jobs” upon ATM/display unit initialization and issue data changes to the scheduled jobs records to perform updates and changes to the ATM & display units.

In an embodiment, the bridge may be software and/or hardware that acts as an intermediary between devices on the network and the CMS/Scheduler. Each bridge may be customized to request information from the CMS/Scheduler and perform actions that facilitate the content or advertisement being transferred to the target device. In an embodiment, the bridge may also act as an agent of information back to the CMS/Scheduler. In an embodiment, different bridges can be implemented to accommodate different device requirements and limitations. All bridges, regardless of device implementation have the same core functionality. That is, the bridge functions to manage network devices, check status of devices on the network, including, sending alerts regarding a device's online availability, communicate information back to the CMS/Scheduler and log the device's online availability in the CMS/Scheduler. The bridge may also mange Ad distribution and proof of play and update proof of play to master schedule in CMS/Scheduler.

In addition to core functionality a bridge may be customized. In an embodiment, bridges dedicated to a specific ATM manufacturer such as Nautilus Hyosung America's (NHA) MoniView RMS may be employed.

In an embodiment, the NHA bridge supports NHA ATMs and display units. These units cannot be accessed directly, but only through the RMS (Remote Management Software). In an embodiment, the NHA bridge allows for the communications between the system and the ATM. It may manage network devices by allowing the ATMs to self-register with MoniView. By using the unique ID for the ATM a terminal ID is obtained. When a bridge, such as a NHA bridge, matches an “Active” terminal ID with a “Tentative” entry from the CMS, it may do the following: 1) update the device's status to Active in the network, 2) schedule a file transfer job that results in an initialization file being sent, via MoniView to the ATM, 3) add the device to a daily journal transfer job, and 4) create a daily job to push a compressed file to the machine.

In an embodiment the bridge may also monitor and provide status of devices by interfacing with MoniView to gather this information.

It may mange Ad distribution and proof of play. The only way certain ATMs accepts remote advertising images is through a compressed file that adheres to a specific structure with specific file names. The file is interpreted as a system level file and causes the ATM to reboot upon transmission. Because of these factors, content and Ads can only be pushed sporadically such as once a day. In an embodiment, the bridge allows ways around this limitation by identifying the file path for the ad asset, copying the file(s) to a local directory, and renaming the files appropriately, appropriately. Once all the files are downloaded, the bridge groups and compresses all files and then registers the file path with the RMS to be moved at a scheduled time.

Since the Ads are transaction Ads, the proof of play is equivalent to the journal entry that occurs at that time. So in an embodiment, another function of the bridge is to tie the Ad to the journal. Accordingly, when all the steps and plays are completed, the bridge transmits the journal, including proof of play to the CMS.

For display units associated with ATMs, the bridge has some different functionality. It may manage the network devices by allowing the display units to self-register with MoniView. The unique ID for the display units comes from the CMS and is assigned before shipping. When the bridge matches an “Active” ID with a “Tentative” entry from the CMS, it may do any one of the following. Update the device's status to Active in the network, check status of devices by interfacing with MoniView to gather information and mange Ad distribution and proof of play. In an embodiment, the display unit accepts remote content or advertising images through a transfer of no more than 80 static images or videos. The NHA Bridge, in order to overcome this limitation finds the file path for the ad asset, copies the file(s) to a local directory, and renames appropriately. Once all files are downloaded, it groups all files in a standard folder and then registers the file path with the RMS to be moved at a scheduled time. Whenever it successfully pushes the next batch of images, it then goes back through the previous batch and updates the estimated play time. When the NHA bridge completes all these steps, it transmits the batch of schedule records to the CMS.

In an embodiment, there may also be a Web bridge to communicate with display units 100 that do not communicate through the ATM network exclusively. The Web bridge may be an all-in-one or tablet computer with an application that displays Ads by accessing a web page, originating on an ad server. These display units stay on the internet and may perform the following tasks. The Web bridge may manage network devices by tracking each unit via, its unique ID such as the unit's serial number. When the Web bridge matches an “Active” ID with a “Tentative” entry from the CMS, it may do the following. It may update the device's status to Active in the network. It may check the status of devices, for example, each time and Ad is called, the date and/or time is logged. If a unit fails to report in, then it is considered offline and no further ads are sent. The Web bridge may assist with the management of Ad distribution and proof of play by checking for the next block (ad) every 15 seconds. At that time, the previous Ad's proof of play is logged, and then sent to the CMS, in real-time.

In an embodiment, the web display may display information chronologically and may display the following information. An hourly timer which may display the following: bridge checks to see if a location is open the next hour and bridge calls schedule for the next hour. The time line may show display unit timers which reflects ads displayed, last time ad displayed, location availability and display status.

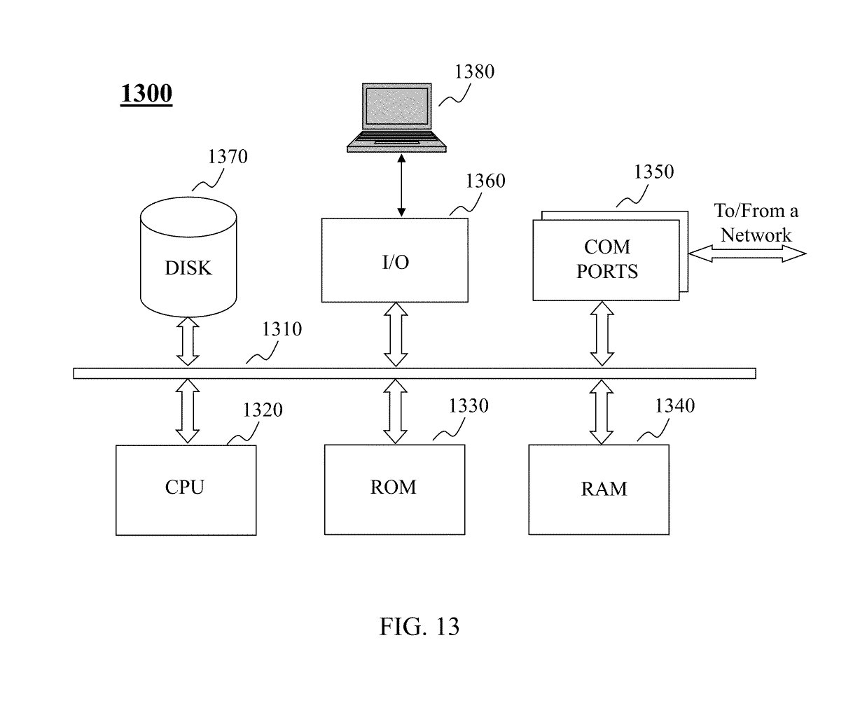

FIG. 13 depicts a general computer architecture on which the present teaching can be implemented and has a functional block diagram illustration of a computer hardware platform which includes user interface elements. The computer may be a general purpose computer or a special purpose computer. This computer 1300 can be used to implement any components of the content display system as described herein. For example, the content server 212, the backend apparatus 204, and the ATM display unit 100 can all be implemented on a computer such as computer 1300, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 1300, for example, includes COM ports 1350 connected to and from a network connected thereto to facilitate data communications. The computer 1300 also includes a central processing unit (CPU) 1320, in the form of one or more processors, for executing program instructions. The exemplary computer platform includes an internal communication bus 1310, program storage and data storage of different forms, e.g., disk 1370, read only memory (ROM) 1330, or random access memory (RAM) 1340, for various data files to be processed and/or communicated by the computer, as well as possibly program instructions to be executed by the CPU. The computer 1300 also includes an I/O component 1360, supporting input/output flows between the computer and other components therein such as user interface elements 1380. The computer 1300 may also receive programming and data via network communications.

Hence, aspects of the methods of displaying content in an ATM network may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the search engine operator or other DCP service provider into the hardware platform(s) of a computing environment or other system implementing a computing environment or similar functionalities in connection with generating the dynamic web pages based on user queries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system for displaying content comprising:
a content display unit for displaying content,
a content storage unit for storing prerecorded content, and
a scheduler for selecting the content to be displayed on the display unit,
wherein the scheduler selects the content for display based on a number of available display units, a total number of desired impressions, and a total number of impressions available.

2. The system of claim 1, wherein the scheduler comprises a microprocessor and wherein the total number of impressions available is determined via the processor based on the number of available units and a number of time slots available for each of the available units.

3. The system of claim 1, wherein the content display unit is incorporated into an ATM machine.

4. The system of claim 1, wherein the content display unit is incorporated into an ATM network.

5. The system of claim 1, wherein the content display unit is a stand alone display unit that is coupled to an ATM network.

6. A method for displaying a plurality of content comprising:
determining via a processor a number of available display units for displaying the plurality of content;
determining, by the processor, a first content position for a first content within a temporal data stream;
computing, by the processor, a second content position for the first content within the temporal data stream;
determining, by the processor, a first content position for a second content within a temporal data stream;
comparing, by the processor, the first content position for the first content with the first content position for the second content to determine if there is a conflict;
time shifting the first content position in a first temporal direction for the second content by a content position unit within the temporal data stream if the comparing determines there is a conflict;
computing, by the processor, a second content position for the second content within the temporal data stream;
comparing, by the processor, the second content position for the first content with the second content position for the second content to determine if there is a conflict; and
time shifting, by the processor, the second content position in a temporal direction opposite the first temporal direction for the second content by the content position unit within the temporal data stream if the comparing determine there is a conflict.

7. The method of claim 6, further comprising
determining, by the processor, a total number of impressions available via the microprocessor based on the number of available units and a number of time slots available for each of the available units.

8. The method of claim 6, wherein the available display units are associated with an ATM machine,

9. The method of claim 6, wherein the available display units are associated with an ATM network.

10. The method of claim 6, wherein the available display units comprise display units incorporated into ATM machines.

11. The method of claim 7, wherein the length of the first or second content requires multiple adjacent time slots to be displayed.

12. The method of claim 11, further comprising:
determining, by the processor, a max_block value of contiguous time slots required to display the first or second content;
determining, by the processor, the number of available contagious available time slots in the temporal data stream;
comparing, using the processor, the number of available contiguous time slots to the determined max_block value available; and
inserting in the temporal data stream the first or second content if the comparing by the processor determines that the number of available contagious available time slots is greater than or equal to the max_block value.
